(19) United States
(12) Patent Application Publication
(10) Pub. No.: US 2021/0237812 A1
(43) Pub. Date: Aug. 5, 2021

(54) VERTICAL IDLER ADJUSTER FOR UNDERCARRIAGE SYSTEM IN TRACK-TYPE MACHINE

(71) Applicant: Caterpillar Inc., Peoria, IL (US)

(72) Inventors: David Jennings Hakes, Princeville, IL (US); William P. Shoemaker, Peoria, IL (US); Lewis Clinton Hunt, Sparland, IL (US)

(73) Assignee: Caterpillar Inc., Peoria, IL (US)

(21) Appl. No.: 16/780,252

(22) Filed: Feb. 3, 2020

(51) Int. Cl. B62D 55/125; B62D 55/10; B62D 55/30

(52) U.S. Cl. CPC B62D 55/125; B62D 55/15; B62D 55/305; B62D 55/10

(57) ABSTRACT

A vertical idler adjuster includes a cam assembly having a cam supported in an adjuster frame for rotation about a cam axis, and an idler support surface having a vertical location that is adjusted relative to the adjuster frame when the cam is rotated. The cam assembly includes a screw linkage having a first set of teeth fixed to rotate with the cam, a drive shaft, and a second set of teeth on the drive shaft and in mesh with the first set of teeth such that rotation of the drive shaft rotates the cam to adjust a vertical position of an idler in an undercarriage system.

### TECHNICAL FIELD

The present disclosure relates generally to a vertical idler adjuster for an undercarriage system in a track-type machine, and more particularly to a cam assembly in a vertical idler adjuster having a screw linkage operable to rotate a cam to vertically adjust an idler.

### BACKGROUND

Track-type machines are used in many applications throughout the world such as construction, forestry, landfills, mining, demolition, and in various other environments. In a typical design, an endless loop of coupled together track links with attached track shoes is positioned at each side of the machine and extends about a plurality of rotatable track engaging elements. Track-type machines, and the undercarriage system including the tracks in particular, can be subjected to extremely harsh conditions. Side loading, bending loads upon components, twisting loads, impacts, and a variety of other phenomena can lead to track strain, wear, and performance degradation. The materials at a work site, including hard rock materials, sand, clay, landfill trash, and various other materials can intrude between and among components in the track. Motion of components in the undercarriage system in contact with one another tends to wear away material from which the undercarriage components are made, which wear can be accelerated or exacerbated by the work site materials. As a result, machine tracks and related components are often built with a particular service life in mind, taking advantage of expected wear patterns and wear rates in the basic design of a component.

It is nevertheless typically necessary to service undercarriage systems over the course of a field service life, to tighten or otherwise adjust the track, inspect and replace seals, and perform other basic maintenance. One phenomenon that can require machine downtime relates to addressing idler height changes in response to wearing of undercarriage system components. The idler is a rotatable track engaging element that passively rotates and guides the track as it is driven by way of a drive sprocket. As material is worn away from the idler, from the track, and potentially other components, the position of the idler relative to other components can change. Idler height that is too great can cause track that is advanced around the idler to contact the underlying substrate at a location that is aft of a desired location, whereas when idler height is too low the track can contact the substrate at a location that is further forward than desired. In either case, the ride quality and performance of the machine can be adversely affected.

Various techniques have been proposed over the years to enable the idler height to be adjusted. Shim packs and the like are sometimes provided and carried on-board the machine, with individual shims being movable from a position above the idler to a position below the idler as wear of the undercarriage components causes idler height to drift lower over time. Still other techniques involve idler support blocks that have off-center holes for the idler shaft. As idler height changes, the support blocks can be repositioned to support the idler shaft at different heights. These and other idler height adjustment strategies can be labor-intensive and require breaking the track, necessitating machine downtime. One known idler height adjustment strategy is set forth in U.S. Pat. No. 7,237,631 to Livesay et al.

### SUMMARY OF THE INVENTION

In one aspect, a vertical idler adjuster for an undercarriage system in a track-type machine includes an adjuster frame having an upper edge and a lower edge, and a cam assembly having a cam supported in the adjuster frame for rotation between a first angular orientation and a second angular orientation about a cam axis. The cam assembly further includes an idler support surface having a first vertical location relative to the adjuster frame when the cam is at the first angular orientation, and a second vertical location relative to the adjuster frame when the cam is adjusted to the second angular orientation. The cam assembly further includes a screw linkage having a first set of teeth fixed to rotate with the cam between the first angular orientation and the second angular orientation, a drive shaft supported in the adjuster frame for rotation, and a second set of teeth formed on the drive shaft and in mesh with the first set of teeth, such that rotation of the drive shaft adjusts the cam between the first angular orientation and the second angular orientation.

In another aspect, an undercarriage system for a track-type machine includes an idler yoke, and a vertical idler adjuster coupled to the idler yoke and having a cam rotatable about a cam axis, and an idler support surface having a vertical location in the undercarriage system that is based on the angular orientation of the cam about the cam axis, and a screw linkage. The undercarriage system further includes an idler rotatable about a horizontally extending idler axis and having an idler height in the undercarriage system that is linked the vertical location of the idler support surface. The screw linkage includes a first set of teeth fixed to rotate with the cam, a drive shaft, and a second set of teeth formed on the drive shaft and in mesh with the first set of teeth. The drive shaft is rotatable about a shaft axis to adjust the idler height by way of varying the angular orientation of the cam about the cam axis.

In still another aspect, a method of adjusting an idler in an undercarriage system includes rotating a drive shaft in a screw linkage of a vertical idler adjuster in the undercarriage system, and adjusting an angular orientation of a cam about a cam axis in the vertical idler adjuster based on the rotation of the drive shaft. The method further includes adjusting a vertical location of an idler support surface of the cam, relative to an idler yoke in the undercarriage system, based on the adjustment to the angular orientation of the cam about the cam axis. The method still further includes raising or lowering a height of the idler in the undercarriage system based on the adjustment to the vertical location of the idler support surface.

### BRIEF DESCRIPTION OF THE DRAWINGS

FIG. 1 is a side diagrammatic view of a machine, according to one embodiment;

FIG. 2 is a partially sectioned view, in perspective, of a portion of an undercarriage system of the machine of FIG. 1;

FIG. 3 is a diagrammatic view of an undercarriage system, according to one embodiment;

FIG. 4 is a sectioned diagrammatic view of a portion of the undercarriage system of FIG. 3;

FIG. 5 is another view of a portion of the undercarriage system of FIG. 3; and

FIG. 6 is a diagrammatic view of an undercarriage system, according to another embodiment.

### DETAILED DESCRIPTION

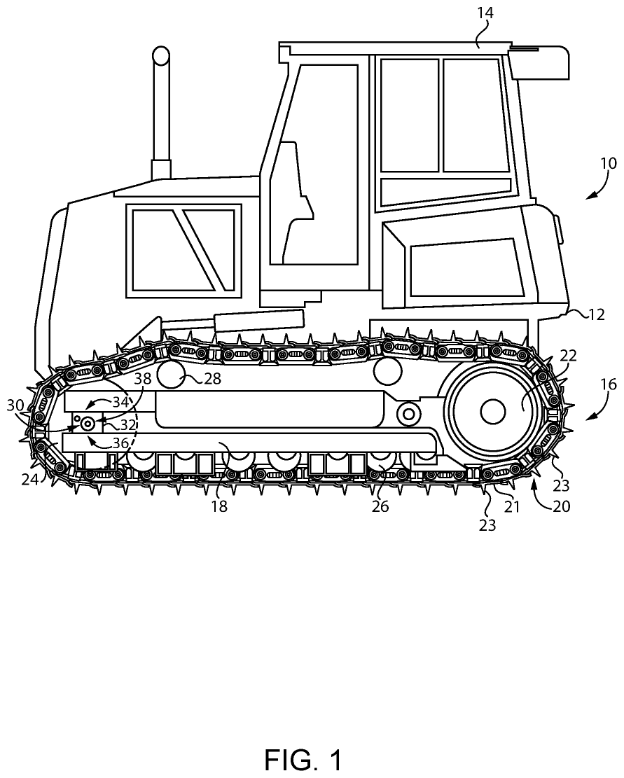

Referring to FIG. 1, there is shown a track-type machine according to one embodiment, and including a machine frame 12, having a cab 14 supported on machine frame 12, and an undercarriage system 16. Undercarriage system 16 includes a track roller frame 18 positioned at a first side of machine frame 12, as shown. It will be appreciated that another track roller frame and associated components will be positioned upon an opposite side of machine frame 12 not visible in FIG. 1. An endless track 20 extends about a plurality of rotatable track-contacting elements including a drive sprocket 22, an idler 24, track rollers 26, and carrier rollers 28. In the illustrated embodiment, track 20 includes a single track in an oval configuration, however, in other embodiments a so-called “high drive” track configuration, a halftrack, a multi-track configuration, or still another design might be employed.

Track 20 will typically include a plurality of track shoes 21 attached to two parallel chains of track links (not numbered), each of track shoes 21 having one or more grousers 23. As discussed above, over the course of a service life of undercarriage system 16 various adjustments to undercarriage system 16 may be required to maintain optimal performance. One parameter typically desirable to periodically adjust relates to an idler “height” often defined as a grouser idler height to roller height ratio. A grouser height above a level substrate directly beneath an idler axis of rotation, compared to a height of a track roller axis above a grouser, defines this ratio. Other quantitative measures of idler height could be used, or quantitative or qualitative measures related to ride quality or machine performance, as a basis for idler height specifications. Undercarriage system 16 is equipped with a vertical idler adjuster 30 for adjusting idler height in undercarriage system 16 in a manner and for purposes further discussed herein.

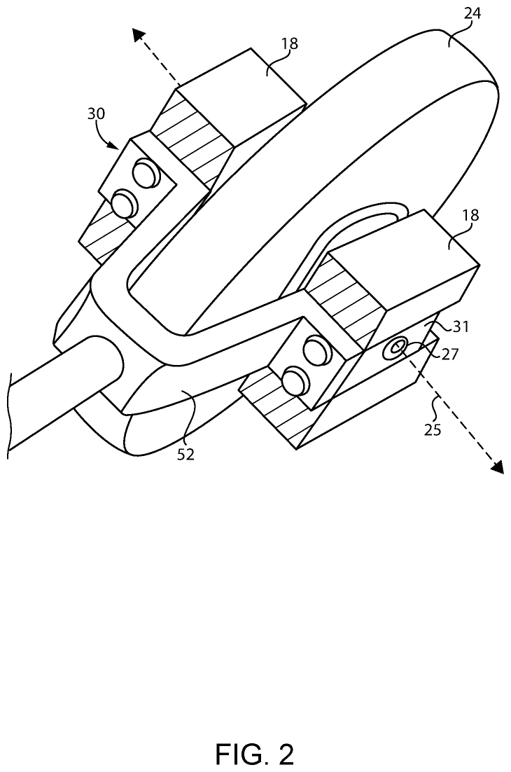

Referring also now to FIGS. 2-4 vertical idler adjuster 30 includes an adjuster frame 32 having an upper edge 34 and a lower edge 36. Vertical idler adjuster 30 further includes a cam assembly 38 having a cam 40 supported in adjuster frame 32 for rotation between a first angular orientation and a second angular orientation about a cam axis 41. Cam assembly 38 further includes an idler support surface 42, with idler support surface 42 having a first vertical location relative to adjuster frame 32 when cam 40 is at the first angular orientation, and a second vertical location relative to adjuster frame 32 when cam 40 is adjusted to the second angular orientation.

Undercarriage system 16 further includes an idler yoke 52 structured to couple to vertical idler adjuster 30, and also to a track tensioning and recoil mechanism 54 supported on track roller frame 18. Idler support surface 42 may further be understood, along with idler 24 itself, to have a vertical location that is adjusted relative to idler yoke 52. Thus, a vertical location of idler support surface 42 is based on an angular orientation of cam 40 about cam axis 41. Track tensioning and recoil system 54 can include an actuator 56, such as a gas spring or coil spring actuator, that urges idler yoke 52 and idler 24 against track 20 in a generally known manner. It will be understood that track tensioning and recoil system 54 enables idler 24 to shift rearwardly in response to certain loads, but biases idler 24 forwardly to maintain track tension. Movement of idler 24, with track tensioning and recoil system 54, occurs generally in horizontal directions. Idler 24 is rotatable about a horizontally extending idler axis 25, and has an idler height in undercarriage system 16 that is linked to the vertical location of idler support surface 42, as further discussed herein.

In FIGS. 1, 3, and 4, vertical idler adjuster 30 is shown upon one side, such as an outboard side, relative to machine frame 12, of machine 10. An additional vertical idler adjuster could be provided on the opposite side of track roller frame 18. In other instances, the sole vertical idler adjuster could be on one side as shown, with the opposite side of track roller frame 18 and idler 24 supported by a passive idler support element 31, or by way of some other support and/or adjustment apparatus. An idler shaft 27 extends through idler 24 and supports idler 24 for rotation. In FIG. 2, idler shaft 27 is shown as it might appear supported in a cam assembly (not numbered) in a vertical idler adjuster configured substantially similarly to cam assembly 38 in vertical idler adjuster 30.

Cam assembly 38 further includes a screw linkage 44 including a first set of teeth 46, for example having a circumferential distribution about cam axis 41, fixed to rotate with cam 40 about cam axis 41 between the first angular orientation and the second angular orientation. Cam assembly 38 further includes a drive shaft 48 supported in adjuster frame 32 for rotation, and a second set of teeth 50 formed on drive shaft 48. Second set of teeth 50 are in mesh with first set of teeth 46, such that rotation of drive shaft 48 adjusts cam 40 between the first angular orientation and the second angular orientation.

From FIG. 4 it can be seen that drive shaft 48 defines a shaft axis 58 having a transverse orientation relative to an orientation of cam axis 41. In the illustrated embodiment, shaft axis 58 is approximately normal to cam axis 41. Adjuster frame 32 may include an adjuster support block 65, having formed therein, a cam bore 67 receiving cam 40, and a shaft bore 68 receiving drive shaft 48. Also in the illustrated embodiment, drive shaft 48 includes a worm gear where second set of teeth 50 include helical teeth. A set of teeth herein could include a single helical circumferential tooth. First set of teeth 46 can include angle-cut teeth, or curved teeth, and might include a square, round, or trapezoidal profile, for example.

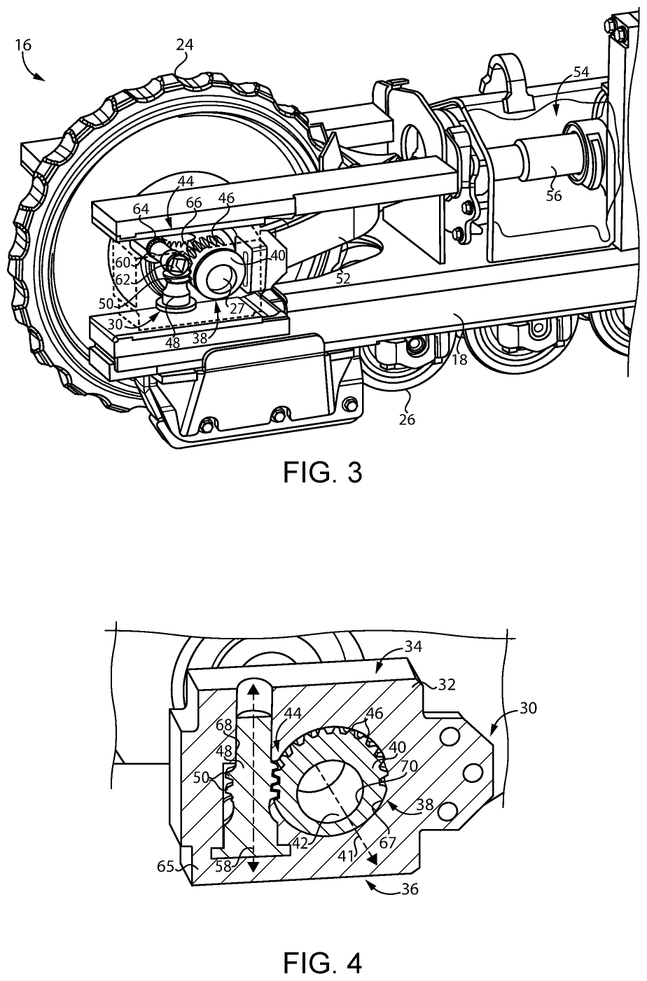

Screw linkage 44 could include a total of two rotatable elements, with drive shaft 48 structured to directly receive a torque input for rotating cam 40 applied by a user. In other instances, screw linkage 44 includes a number of rotatable elements greater than two. From FIG. 3 it can be seen that screw linkage 44 also includes an input shaft 60. Input shaft 60 will be understood to define an input shaft axis that is parallel to cam axis 41, and perpendicular to shaft axis 58. In other instances, by suitably configuring the shapes and/or orientations of teeth in screw linkage 44 different angular relationships than those shown amongst the various axes could be obtained.

Input shaft 60 has a tool-engagement recess 62 formed therein, and structured to receive a tool, such as for hand-operated rotation of drive shaft 48. Tool-engagement recess 62 could include a square female socket recess, for example, to receive a socket wrench manipulated by a technician. Tool engagement recess 62 could also have a hex shape, a male configuration, or still another geometry. A user could hand operate vertical idler adjuster 30 using a manual wrench as described, but in other instances could employ a hydraulic torque wrench, a pneumatic device, or any other suitable hand-operated motorized or non-motorized tool. In some embodiments, a user can rotate input shaft 60 a prescribed number of turns, or partial turns, to effectively crank idler 24 up or down a desired distance. For instance, vertical idler adjuster can be configured by way of tooth sizes, gear ratios, tooth angles, etc. such that “X” number of turns of input shaft 60 yields “Y” millimeters of vertical idler adjustment.

Input shaft 60 includes a third set of teeth 64 in mesh with a fourth set of teeth 66 upon drive shaft 48. It should be appreciated that a great many different screw linkage arrangements, numbers of rotating components, and still other attributes are within the context of the present disclosure. For instance, first set of teeth 46 may be formed on cam 40. In other embodiments the first set of teeth could be formed on an outer rotatable member that supports cam 40, rather than upon camp 40 itself. It can also be noted that a circumferential distribution of first set of teeth 46 about cam axis 41 is less than 360°, and is approximately 180°, meaning that an approximately one-half rotation of cam adjusts idler 24 through its full range of heights.

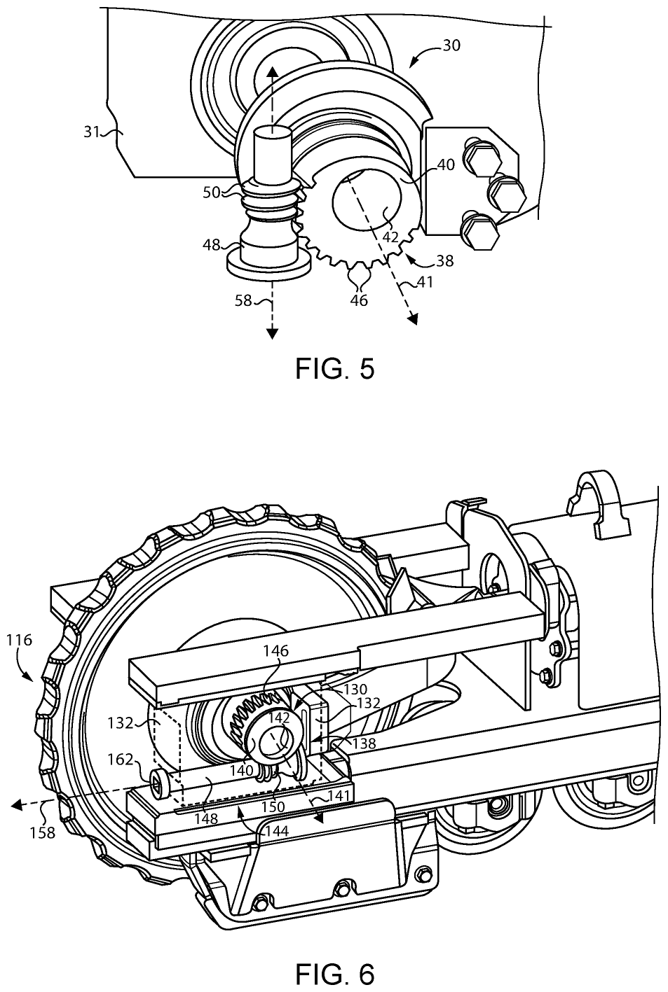

Referring also now to FIG. 5, there is shown part of vertical idler adjuster 30 where cam 40 has been rotated from a first angular orientation about cam axis 41, as in FIG. 4, and thereby adjusted to a second angular orientation about cam axis 41. It can be seen that a rotation of cam 40 between the first angular orientation and the second angular orientation is equal to approximately 180°, with the mesh between first set of teeth 46 and second set of teeth 50 causing the rotation of cam 40 as drive shaft 48 is rotated. Drive shaft 48 might be rotated numerous times to adjust cam 40 from the angular orientation depicted in FIG. 4 to the second angular orientation depicted in FIG. 5, for example, drive shaft 48 might be rotated five times, ten times, twenty times, or even a greater number of times to rotate cam 40 approximately 180°. This general configuration assists in providing sufficient mechanical advantage for a technician to adjust idler height without a need for power tools. It can also be appreciated that cam 40 is adjusted between a first angular orientation and a second angular orientation defining extremes of idler height in undercarriage system 16, and an essentially infinite number of angular orientations of cam 40 between the extremes of idler height can be obtained, enabling a user to make relatively fine adjustments to idler height as desired.

In a practical implementation strategy idler support surface 42 includes a peripheral surface of cam 40 and has an arc shape, such as a circular shape as shown. Idler support surface 42 may further form an idler shaft support bore 70 where configured as an inner peripheral surface of cam 40. In other instances, idler support surface 42 might include an outer peripheral surface of cam 40. Idler support surface 42 and thus idler shaft support bore 70 are arranged eccentrically relative to cam axis 41 in the illustrated embodiment.

Referring now to FIG. 6, there is shown an undercarriage system 116 according to another embodiment. In undercarriage system 16 there are a number of similarities with the forgoing embodiment, and the description of other embodiments herein, can be understood to apply generally to undercarriage system 116 except where otherwise indicated or apparent from the context. Undercarriage system 116 includes a vertical idler adjuster 130 including a cam assembly 138 having a cam 140 adjustable between a first angular orientation and a second angular orientation about cam axis 141, and including an idler support surface 142 having a first vertical location relative to an adjuster frame 132 when cam 140 is at the first angular orientation, and a second vertical location relative to adjuster frame 132 when cam 140 is adjusted to the second angular orientation.

Cam assembly 130 also includes a screw linkage 144 having a first set of teeth 46 upon cam 140 with a circumferential distribution about cam axis 141 and fixed to rotate with cam 140, and a drive shaft 148 supported in adjuster frame 132 for rotation. A second set of teeth 150 are formed on drive shaft 148 and in mesh with first set of teeth 146, such that rotation of drive shaft 148 adjusts cam 140 between the first angular orientation and the second angular orientation. Drive shaft 148 is generally horizontally oriented, and extends fore and aft relative to cam axis 141 and other parts of undercarriage system 116. A tool engagement recess 162 is formed in drive shaft 148, and thus accessible generally from a front end of vertical idler adjuster 130 in a space that extends between vertical idler adjuster 130 and a track when undercarriage system 116 is assembled for service.

### INDUSTRIAL APPLICABILITY

As discussed herein it can be desirable to periodically adjust an idler height in a track-type machine. In many instances, idler height will be raised to compensate for wearing away of material such as from an outer rim of a rotatable idler, and from components of a track that is advanced around the rotatable idler, including track pins, track pin bushings, or track links, depending upon design of the undercarriage system. The rotatable idler can be understood to become slightly smaller in outer diameter as wear occurs, and will thus have a tendency to migrate lower, eventually causing a track to contact an underlying substrate with its grousers at a location somewhat forward of what is desirable, especially for fine dozing activities such as finishing and contouring, and potentially impacting ride quality. In such instances idler height will be raised to compensate for the wear. In other instances, however, and for example when an undercarriage system is being first assembled, or reassembled after service, it can be desirable to lower idler height.

Vertical idler adjusters 30 and 130, and others contemplated herein, can thus be used to adjust idler height either up or down. In a typical application adjusting an idler in an undercarriage system according to the present disclosure can include rotating a drive shaft in a screw linkage of a vertical idler adjuster in the undercarriage system, and adjusting an angular orientation of a cam about a cam axis in the vertical idler adjuster based on the rotation of the drive shaft. Adjusting an idler in an undercarriage system can further include adjusting a vertical location of an idler support surface of the cam, relative to an idler yoke in the undercarriage system, based on the adjustment to the angular orientation of the cam about the cam axis. In this general manner, and depending upon a direction of rotation of the drive shaft in the screw linkage, a height of the idler is raised or lowered based on the adjustment to the vertical location of the idler support surface. In certain instances, rather than manual or hand operation, a motorized or otherwise powered adjustment of idler height could be performed according to the present disclosure. Moreover, other screw linkages than those disclosed herein, for example a motorized or hand-cranked ball screw drive, or lead screw drive could also be employed.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed:

1. A vertical idler adjuster for an undercarriage system in a track-type machine comprising:
an adjuster frame having an upper edge and a lower edge;
a cam assembly including a cam supported in the adjuster frame for rotation between a first angular orientation and a second angular orientation about a cam axis, and an idler support surface, the idler support surface having a first vertical location relative to the adjuster frame when the cam is at the first angular orientation, and a second vertical location relative to the adjuster frame when the cam is adjusted to the second angular orientation; and
the cam assembly further including a screw linkage including a first set of teeth fixed to rotate with the cam between the first angular orientation and the second angular orientation, a drive shaft supported in the adjuster frame for rotation, and a second set of teeth formed on the drive shaft and in mesh with the first set of teeth, such that rotation of the drive shaft adjusts the cam between the first angular orientation and the second angular orientation.

2. The idler adjuster of claim 1 wherein the drive shaft defines a shaft axis having a transverse orientation relative to an orientation of the cam axis.

3. The idler adjuster of claim 2 wherein the drive shaft includes a worm gear.

4. The idler adjuster of claim 2 wherein the adjuster frame includes an adjuster support block having formed therein, a cam bore receiving the cam, and a shaft bore receiving the drive shaft.

5. The idler adjuster of claim 2 wherein the idler support surface includes a peripheral surface of the cam having an arc shape and arranged eccentrically relative to the cam axis.

6. The idler adjuster of claim 5 wherein the peripheral surface includes an inner peripheral surface of the cam forming an idler shaft support bore.

7. The idler adjuster of claim 1 wherein the first set of teeth are formed on the cam.

8. The idler adjuster of claim 7 wherein a circumferential distribution of the first set of teeth about the cam axis is less than 360 degrees.

9. An undercarriage system for a track-type machine comprising:
an idler yoke;
a vertical idler adjuster coupled to the idler yoke and including a cam rotatable about a cam axis, an idler support surface having a vertical location in the undercarriage system that is based on an angular orientation of the cam about the cam axis, and a screw linkage;
an idler rotatable about a horizontally extending idler axis and having an idler height in the undercarriage system that is linked to the vertical location of the idler support surface;
the screw linkage including a first set of teeth fixed to rotate with the cam, a drive shaft, and a second set of teeth formed on the drive shaft and in mesh with the first set of teeth; and
the drive shaft is rotatable about a shaft axis to adjust the idler height by way of varying the angular orientation of the cam about the cam axis.

10. The undercarriage system of claim 9 further comprising a track tensioning mechanism coupled to the idler yoke.

11. The undercarriage system of claim 9 wherein the idler includes an idler shaft, and the idler support surface includes a peripheral surface of the cam forming an idler shaft support bore receiving the idler shaft.

12. The undercarriage system of claim 11 wherein the idler shaft support bore is eccentrically arranged relative to the cam axis.

13. The undercarriage system of claim 9 wherein the drive shaft defines a shaft axis having a transverse orientation relative to an orientation of the cam axis.

14. The undercarriage system of claim 13 wherein the drive shaft includes a worm gear, and the first set of teeth are formed on the cam.

15. The undercarriage system of claim 14 wherein the circumferential distribution of the first set of teeth about the cam axis is less than 360°.

16. The undercarriage system of claim 14 wherein the vertical idler adjuster includes an adjuster support block having formed therein, a cam bore receiving the cam, and a shaft bore receiving the drive shaft.

17. The undercarriage system of claim 16 wherein the drive shaft includes a tool engagement recess for hand-operated rotation of the drive shaft.

18. A method of adjusting an idler in an undercarriage system comprising:
rotating a drive shaft in a screw linkage of a vertical idler adjuster in the undercarriage system;
adjusting an angular orientation of a cam about a cam axis in the vertical idler adjuster based on the rotation of the drive shaft;
adjusting a vertical location of an idler support surface of the cam, relative to an idler yoke in the undercarriage system, based on the adjustment to the angular orientation of the cam about the cam axis; and
raising or lowering a height of the idler in the undercarriage system based on the adjustment to the vertical location of the idler support surface.

19. The method of claim 18 wherein the rotating of the drive shaft includes rotating a worm gear in the screw linkage having teeth in mesh with teeth of the cam.

20. The method of claim 18 wherein the adjusting of the vertical location of the idler support surface includes rotating a surface of the cam forming an idler shaft support bore that is arranged eccentrically relative to the cam axis.
